(19) United States
(12) Patent Application Publication
(10) Pub. No.: US 2011/0193908 A1
(43) Pub. Date: Aug. 11, 2011

(54) INKJET PRINTING DEVICE WITH COMPENSATION FOR JET VELOCITY

(75) Inventor: Christian Araszkiewiez, Charmes Sur Rhone (FR)

(73) Assignee: MARKEM-IMAJE, Bourg-les-Valence (FR)

(21) Appl. No.: 13/057,457

(22) PCT Filed: Aug. 11, 2009
(86) PCT No.: PCT/EP2009/060378

§ 371 Date: Apr. 27, 2011

(30) Foreign Application Priority Data
Aug. 11, 2008 (FR) 0855511

(51) Int. Cl. B41J 29/38

(52) U.S. Cl. 347/14

(57) ABSTRACT

The invention relates to a process for compensating for effects related to variations in the velocities of electrically charged ink drops (40) in a jet (4) output from a print head of a printer, the drops being electrically charged by charge electrodes (30), consisting of:
measuring the velocity of the jet on the downstream side of a drop charge zone, and calculating a variation in this measured velocity,
for each drop, determining a voltage correction value to be applied to the charge electrodes, as a function of said measured velocity variation.

### TECHNICAL DOMAIN AND PRIOR ART

The invention relates to an improvement in the print quality of inkjet printers, particularly so-called wide format printers.

More specifically, it deals with a process and a device to compensate for variations in the jet velocity, particularly when a large number of jets is used in the print head.

Industrial inkjet printers can be used to print character strings, logos or more highly sophisticated graphic patterns on products being manufactured or on packaging, starting from variable digital data frequently under difficult environmental conditions.

There are two main technological families of printers of this type; one is composed of “drop on demand” printers and the other of “continuous jet” printers.

In all cases, at a given moment, the print head projects a combination of drops aligned on a segment of the surface to be printed in a very short time. A new combination of drops is projected after relative displacement of the head with respect to the support, in the direction usually perpendicular to the segments addressed by the head nozzles. Repetition of this process with variable combinations of drops in the segment and regular relative displacements of the head with respect to the product, lead to printing of patterns with a height equal to the height of the segment and a length that is not limited by the print process.

“Drop on demand” printers directly and specifically generate the drops necessary to make up the segments of the printed pattern. The print head for this type of printer comprises a plurality of ink ejection nozzles usually aligned along an axis. A usually piezoelectric actuator, or possibly a thermal actuator generates a pressure pulse in the ink on the upstream side of the nozzle, locally causing an ink drop to be expelled by the nozzle concerned, to determine whether or not a drop is ejected depending on the required combination at a given moment, for each nozzle independently.

Continuous jet printers operate by using electrically conducting ink under pressure and allowed to escape from a calibrated nozzle thus forming an inkjet. The inkjet is broken down into regular time intervals under the action of a periodic stimulation device, at a precise location of the jet. This forced fragmentation of the inkjet is usually induced at a so-called jet “break” point by periodic vibrations of a piezoelectric crystal, located in the ink on the input side of the nozzle. Starting from the break point, the continuous jet is transformed into a stream of identical ink drops at a uniform spacing. A first group of electrodes called “charge electrodes” is placed close to the break point, the function of which is to selectively transfer a predetermined quantity of electric charge to each drop in the stream of drops. All drops in the jet then pass through a second group of electrodes called “deflection electrodes”; these electrodes, to which very high voltages of the order of several thousand volts are applied, generate an electric field that will modify the trajectory of the charged drops.

In a first variant of continuous jet printers called “deviated continuous jet” printers, a jet is capable of successively projecting drops towards the different possible impact points of a segment on the product to be printed. In this first variant, the charge quantity transferred to the jet drops is variable and each drop is deflected with an amplitude proportional to the electric charge that it received. The segment is scanned to successively deposit the combination of drops onto a segment much more quickly than the relative displacement of the head with respect to the product to be printed, such that the printed segment appears approximately perpendicular to said displacement. Drops not deflected are recovered in a gutter and are recycled into the ink circuit.

A second variant of continuous jet printers called “binary continuous jet” printers is differentiated from the previous variant mainly by the fact that the trajectories of the ink drops may only have two values: deflected or not deflected. In general, the non-deflected trajectory is intended to project a drop on the product to be printed and the deflected trajectory directs the unprinted drop to a recovery gutter. In this variant, a nozzle addresses a point on the pattern to be printed on the product, and printing of characters or graphic patterns requires the use of a number of nozzles in the head corresponding to the segment height, for a given resolution.

Applications of industrial inkjet printers can be broken down into two main domains. One of these domains relates to coding, marking and customisation (graphic) of printed products over small heights; this involves print heads comprising one or several jets based on the so-called “deviated continuous jet” technology and several tens of jets using the “binary continuous jet” or “drop on demand” technology.

The other application domain relates to printing, mainly graphic, of flat products with large surface areas for which the width may be very variable depending on the applications and may be up to several meters, the length of which is not limited by the printing process itself. For example, this type of application includes printing of monumental posters, truck tarpaulins, strip textiles or floor or wall coverings, and others.

These printers use print heads comprising a large number of nozzles. These nozzles cooperate to project combinations of drops at the ordered instants, each combination addresses a straight segment on the product.

Two configurations of inkjet printers are normally used to print on large areas. The first configuration can be used when the print rate is relatively low. In this case, printing is done by the print head scanning above the product. The head moves transversely with respect to the advance direction of the product that itself is parallel to the segment addressed by nozzles in the head. This is the usual operating mode of an inkjet office automation printer. The product moves forward intermittently in steps with a length equal to the height of the segment addressed by the nozzles in the print head, or a sub-multiple of this height, and stops during transverse displacement of the print head. The productivity of the machine is higher when the height of the segment addressed by the head nozzles is high, but this height does not usually exceed a fraction of the order of 1/10th to ⅕th of the width of the product. The “drop on demand” technology is preferred for this configuration, due to the low weight of print heads that can be transported more easily and the greater difficulty of making large print heads using this technology, as is essential in the second configuration. Furthermore, the intermittent printing makes it easier to manage a constraint inherent to this technology, which is that the head has to be brought to a maintenance station periodically to clean the nozzles.

The second configuration helps to obtain the maximum productivity by making the product pass forwards continuously at the maximum printing speed of the head. In this case, the print head is fixed and its width is the same order as the width of the product. The segment addressed by the nozzles in the print head is perpendicular to the direction of advance of the product and the height is equal to at least the width of the product. In this configuration, the product advances continuously during printing as with existing photogravure printing or silk screen printing techniques using rotary frames but with the advantage of digital printing that does not require the production of expensive tools specific to the pattern to be printed.

The development of wide format inkjet printers, typically wider than 1 meter and particularly between 1 meter and 2 meters wide, assumes that it is possible to integrate a large number of nozzles into a single print head. This large number depends on the width to be printed, and may for example be of the order of a few hundred, for example 100 to 1000, for example about 400 or 700 for the “continuous deviated jet” technology and a few thousand for the “continuous binary jet” and “drop on demand” technologies. The Burlington U.S. Pat. No. 4,841,306 describes a wide format print head using the “binary continuous jet” technology in a single piece for which the nozzle plate in particular consists of a single part. The Imperial Chemical Industries Inc. U.S. Pat. No. 3,956,756, also describes a wide format head using the “deviated continuous jet” technology. Faced with the difficulty of making this type of head, modular architectures have been developed in which the print head is broken down into small modules that can be made and controlled more easily, and that are then assembled on a support beam. As can be seen in patent EP 0 963 296 B1 or patent application US 2006/0232644, this solution is suitable for “drop on demand” printers. However, modules have to be stacked and offset for size reasons, the connection to zones printed by the modules being made by the management of print start times for each module. The “deviated continuous jet” technology is particularly suitable for modular architectures, and this technology enables a space of several millimetres between jets, so that jets and their functional constituents can be placed side by side over large widths. This possibility of putting jets side by side indefinitely can be transferred onto modules of several jets as was disclosed in patent FR 2 681 010 granted to the applicant and entitled “Module d'impression multi-jet et appareil d'impression comportant plusieurs modules” (Multi-jet print module and printing device comprising several modules). This patent FR 2 681 010 describes a wide “deviated continuous” multi-jet print head composed of the assembly of print modules with m jets, typically 8 jets, placed side by side on a support beam, this support beam also performing functions to supply ink to the modules and to collect ink not used.

In this type of industrial application in which the environment is often severe, wherever possible drops and their trajectories before impact are protected from external disturbances (air drafts, dust, etc.), which are random in nature preventing control of print quality. This is why drops usually travel between the nozzles and the exit from the head in a relatively confined cavity open to the outside mainly through the drop outlet orifice. This orifice is usually a slit, that should be kept as narrow as possible so that protection of the trajectories is as efficient as possible.

The use of wide format inkjet printers creates some problems.

In particular, undesirable velocity variations can occur in each of the ink jets.

FIG. 6 very schematically shows an ink supply device for a known type of wide format ink jet printer. On this figure, the N print modules are identified with reference Mi, i=1, . . . N. Each of these print modules is supplied with ink from a common reservoir 111. There is a filter 119 on the upstream side of this reservoir and on the ink circulation path.

Ink distributed from this reservoir passes through a filter Fi (i=1, . . . N) at each print module Mi, that is common to all jets in this module. During operation of the device, a change to the state of filter 119 will have exactly the same influence on operation of all modules, and particularly on the velocity of each jet in each module. But the state of each filter Fi will also change, in a random manner from one module to the next. In other words, the different filters Fi will become clogged non-uniformly. Internal dirt collection phenomena in the modules themselves can cause variations of jet velocities for the same supply pressure.

The solution that consists of replacing a previously used module by a module that has not yet been used cannot solve this problem, because the jets ejection velocity in the new module will be different from the ejection velocity from jets in modules that have not been changed.

The solution that consists of varying the pressure at the inlet to each module is not satisfactory, for the following reasons.

In known techniques, the need to have an extremely high performance pressure control to maintain the positioning stability of the drops printed on the support, the volume of the corresponding actuators and their cost make it impossible to envisage individual slaving of the velocity of the jets in a module. The need to be able to change ink quickly also induces <<simplicity>> constraints on the definition of ink inlet ducts to print modules.

### PRESENTATION OF THE INVENTION

The invention thus solves all or some of the disadvantages or problems mentioned above and discloses a device capable of improving the wide format print quality.

In particular, the invention relates to a process for compensating effects related to variations in ink drop jet velocities or the velocities of drops in this jet by acting on the charge of the drops as a function of the measured velocity of the drops or the jet (the expression <<jet velocity>> is used most frequently in the following description).

To achieve this, the invention relates to a process for compensating for the variation in the velocity of a jet by modifying the charge voltages of ink drops in the jet from a print head in a printer.

Following steps are implemented for this purpose.
a measurement of the velocity of a jet or of a number of drops in a jet, for example a few tens of drops, on the downstream side of a drop charge zone, and the calculation or estimate of a variation of this velocity, for example compared with a velocity called the jet reference velocity;
determination of a voltage correction value to be applied to drop charge electrodes, as a function of said measured velocity variation, for a plurality of jet drops.

Drop trajectories can be modified by deviation electrodes arranged for each jet on the downstream side of charge electrodes and jet velocity measurement means.

A charge correction may be applied in a variable manner to drops in a jet as a function of the position of each of these drops in the jet.

According to some aspects of this invention, the reference velocity of a jet, that is a characteristic of a jet in good operating condition, is used. Such a characteristic may be prerecorded or memorised.

According to yet another aspect, the fact that a jet belongs to a group or a set of adjacent jets comprising more than 2 jets and for example 8 jets, is also used. Such a group can be called a module.

The average reference velocity of the jets in a group of jets or a module can be calculated using the reference velocity of each jet in this group or this module.

Velocity measurements for a jet may be validated, or a process according to the invention may comprise a validation step, to indicate whether or not measurements should be considered as being incorrect.

A difference between the measured jet velocity and its real velocity causes difficulties.

The jet velocity measurement can be qualified as being valid or invalid using the measured velocity for this jet, its reference velocity, and the average velocity of jets in a module or a group of jets to which this jet belongs and the average reference velocity of the jets in this group.

More particularly, the following steps can be carried out to determine whether or not the measured velocity of each jet in a group of jets can be considered as being valid:
calculate a first difference between the measured average velocity and the reference average velocity of a set of jets in said group of jets;
calculate a second difference between the instantaneous velocity and the reference velocity of each jet in said group of jets;
calculate a third difference between the first difference and the second difference.

If this third difference is less than a given threshold, the measured jet velocity is considered to be valid, otherwise it is considered to be invalid.

According to one variant, it is possible to:
set up an average velocity for all jets in a group of jets or a module;
calculate the difference between this average velocity and the average of the reference velocities of jets in the group or the module considered (this difference is related to phenomena to be compensated, such as clogging of module filters);
correct the measured velocity by this difference.

This corrected velocity is then compared with the reference velocity of the jet.

If the difference between the corrected velocity and the reference velocity is greater than a predetermined value, the measurement is declared to be incorrect.

Several correction methods can then be applied.

According to a first correction method, after the velocity of each jet is measured, this velocity is then compared with the reference velocity of the jet. A correction is applied (on the charge of the drops, as in the invention), that compensates for the difference between these two velocities. However, this method presents the disadvantage that it is not capable of detecting anomalies in the measured jet velocities or anomalies in the velocities themselves. This method does not require the use of any measurement validation procedure like that described above.

According to a second correction method, after individually measuring the velocity of each jet in a group of jets, each of these measurements is validated, for example as described above.

If the measurement for at least a given predetermined number x (where x can be configured, x>0) of jets among the plurality of jets in the group is valid, then the charge is corrected so as to obtain a correction to the velocity of each jet in the module, equal to the difference between the average velocity of all jets in the group of jets, and the average of the reference velocities of jets in this group.

According to a third correction method, similar to the previous one, the following are applied:
the average correction (to obtain a velocity correction equal to the difference between the average velocity of all jets in the group of jets and the average reference velocity for these jets) to the jets for which the measurement is not valid, according to the meaning already described above;
and an individual correction (to obtain a velocity correction equal to the difference between the individual velocity of the jet and the reference velocity of this jet) to the jets for which the measurement is valid, according to the meaning already described above.

The invention also relates to a print head of an inkjet print device, comprising:
ink ejection means to produce a jet of ink drops;
charge electrodes, to electrically charge drops in a jet
means of measuring the velocity of each drop, on the downstream side of the electrodes to electrically charge the drops, and to calculate a variation of this measured velocity of each drop (for example relative to a velocity referred to as the nominal velocity);
means of determining one or more voltage correction values to be applied to drop charge electrodes, as a function of said variation of this measured velocity.
deviation electrodes to modify drop trajectories.

The means of determining one or more voltage correction values to be applied to charge electrodes can determine a variable correction as a function of the position of several drops in a jet.

A print head according to the invention can also comprise means for determining whether or not the velocity measurement of each jet in a group of jets can be considered as being valid. Such means may be designed to:
calculate a first difference between the measured average velocity and the reference average velocity of each jet in said group of jets;
calculate a second difference between the instantaneous velocity and the reference velocity of each jet in said group of jets;
calculate a third difference between the first and the second difference;
determine whether or not a measurement is valid, as a function of the value of the third difference.

Preferably, the means of determining a voltage correction value to be applied to the charge electrodes of the drops are or can be used to determine a voltage correction, or are programmed to determine such a correction, in order to obtain:
a correction to the velocity of each jet individually, equal to the difference between the measured velocity of the jet and its so-called reference velocity;
or a correction to the velocity of each jet in a group of jets, equal to the difference between the average velocity of all jets in the group of jets, and the average of the so-called reference velocities of the jets in this group, if the number of jets in the group with a valid measurement is greater than a predetermined number;
or a correction to the velocity in each jet in a group of jets:
equal to the difference between the average velocity of all jets in the group of jets, and the average of the so-called reference velocities of the jets in this group, if the jet has an invalid velocity measurement;
equal to the difference between the measured velocity of the jet and its so-called reference velocity, if the jet has a valid velocity measurement.

According to one particular embodiment, a print head comprises a support block to hold the charge electrodes in place, means of measuring the velocity of each drop, and the deviation electrodes.

According to another more particular embodiment, a print head according to the invention comprises a body fixed relative to a support beam, itself comprising said means of producing a jet of ink drops, the support block being fixed on this fixed part, but free to move relative to it.

Preferably, the block holding the electrodes and velocity measurement means is pivotably mounted about a rotation axis defined in the fixed body; the charge electrodes, means for measuring the velocity of each drop, and the deviation electrodes are aligned on the trajectory of the drops in a jet, in a lowered position of the block relative to the fixed body.

The block of electrodes may be free to pivot between its operating position and an extreme raised position to allow maintenance of ink ejection means, means of measuring the velocity of each drop and/or the block of electrodes.

In a print head according to the invention, the fixed body and the electrodes block may advantageously define an output orifice when in the lowered position of the block relative to the fixed part, through which at least one part of the ejected ink passes to print on a moving support.

According to one embodiment, the lower part of the electrodes block is in the form of a shoe, this shoe being separated from the body by a width defining the output orifice, a volume delimited by the body and the block in the operating position defining a cavity opening onto the output orifice.

The ink ejection means may be adapted to eject ink in the form of continuous jets, or to eject one or several drops on request.

The invention also relates to a print device according to the invention, particularly a wide type printer, comprising a plurality of print modules side by side along a same transverse axis.

The invention also relates to a print module with “m jets” (1≦m≦40 or 50 or more) that can be placed side by side, in other words ejecting a number equal to m ink jets, operating according to the invention.

It also relates to a wide print head using the “deviated continuous jet” technology comprising X (X>1) modules, as explained above. For example X can be be of the order of a few hundred, for example 100 to 1000, for example about 400 or 700 for the “continuous deviated jet” technology and a few thousand, for example between 1000 and 2000 or 5000, for the “continuous binary jet” and “drop on demand” technologies.

Some aspects of the invention, that improves the print quality and the availability of wide format inkjet printers, are applicable to “drop on demand” or “binary continuous jet” printers, but it is particularly suitable for “deviated continuous jet” printers in which all aspects of the invention can be used. Therefore, the invention will be described in the following in the context of this preferred type of printers.

### BRIEF DESCRIPTION OF THE DRAWINGS

Other advantages and characteristics of the invention will become clearer after reading the detailed description given below with reference to the following figures:

FIG. 1A shows a wide format multi-jet print head (T) according to the state of the art, with jets in operation but without printing on the support (S).

FIG. 1B is a sectional view along axis C-C in FIG. 1A, showing a multi-jet print module (Mi) integrated into the print head (T) according to the state of the art, and operating according to the “deviated continuous jet” technology.

FIG. 2 diagrammatically shows a print head with means of electrostatically charging drops, means of measuring the drop velocity, and means of deflection for printing;

FIG. 3 diagrammatically shows a cluster of drops between two deflection electrodes;

FIG. 4 diagrammatically shows a device for measurement of drop velocities in a jet;

FIG. 5 shows the profiles of voltage correction curves as a function of jet velocity variations;

FIG. 6 shows a fluid flow diagram in a wide multi-jet print device.

### DETAILED PRESENTATION OF PARTICULAR EMBODIMENTS

The preferred technology for producing a wide format inkjet printer is the “deviated continuous jet”.

The use of a large number of simultaneous jets in a print head at a constant spacing, addressing connectable print zones on the support to be printed and thus enabling printing over large widths, is described in French patent FR 2 681 010 granted to the applicant and entitled “Module d'impression multi-jet et appareil d'impression comportant plusieurs modules” (Multi-jet print module and print device comprising several modules).

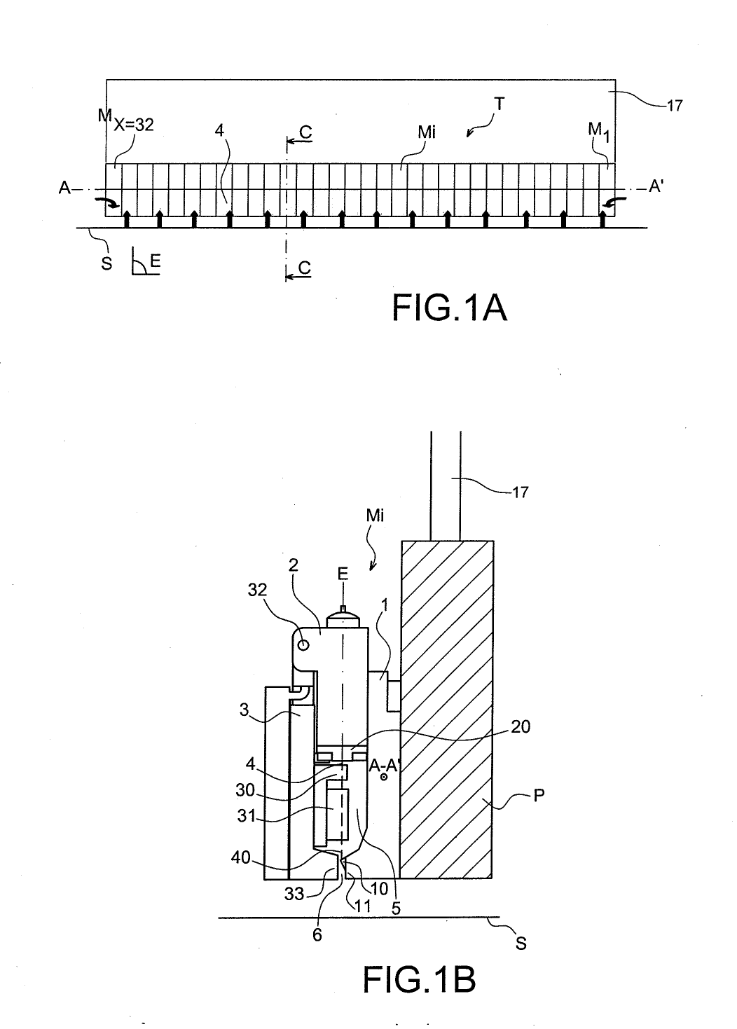

FIG. 1A shows a known wide multi-jet print head structure (T). It comprises X print modules (Mi) each producing m jets, for example 8 jets, and placed side by side on a support beam (P) (FIG. 1B), which also performs functions to supply modules with ink and to collect unused ink.

Thus, a wide print head (T) comprises X print modules (Mi) and extends along an axis A-A′ transverse to the moving support (S) to be printed (FIG. 1A).

Reference 17 denotes a set of electronic means to control the entire device, and therefore each jet of each module. For example, these means 17 comprise an electronic control card for each jet or for a set of jets. For example, each electronic card controls the eight jets in a print module.

As illustrated on FIG. 1B, each print module according to the invention (Mi) is composed firstly of a body 1 supporting an ink ejector 2 with m jets 4 of drops 40 and integrating a set of m recovery gutters 10, and also a block of retractable electrodes 3 supporting two groups of electrodes for the deflection of some drops: a group of charge electrodes 30 and a group of deflection electrodes 31. More precisely, the ink ejector 2 is adapted to eject ink in the form of continuous jets 4, the break point of each jet being placed close to the middle of the charge electrodes 30 in the electrodes block 3. The jets 4 are parallel in a vertical plane (E) and the drops 40 travel from the nozzles of the plate 20 fixed to the ink ejector 2 towards the orifice of the corresponding recovery gutter 10. As explained below, each print module according to the invention also comprises means (not visible in FIG. 1B) of measuring the velocity of charged drops in each jet.

The electrodes block 3 can be lowered or raised, by pivoting it about an axis 32 defined in the body 1. This axis is transverse to a direction of movement of the print support, When this block is in the extreme down position, in other words in the operating position, the electrodes 30, 31 are inserted in the path of the drops 40 and control the charge and deflection of some drops that escape from the gutter 10, and are deposited on the support to be printed (S).

When in the extreme down position, each electrodes block 3 forms an internal cavity 5 with the body 1 and the ink ejector 2. More precisely, the internal cavity 5 is limited at the back by the body 1, at the front by the electrodes 30, 31, and the drop velocity measurement means are limited at the top by the nozzle plate 20 and at the bottom by the projection 11 of the body integrating the gutter 10 and the shoe or toe 33 of the electrodes block 3 respectively. The space between the projection 11 and the shoe or toe 33 of the electrodes block 3 defines an output orifice 6 forming a slit through which drops 40 can pass for printing (FIG. 1B). This slit 6 is as narrow as possible to assure confinement of the cavity 5. Such a confinement can protect the drops currently being deflected from external disturbances such as air drafts or projections of ink, dust or other products, for which the random nature prevents control over the print quality.

When all electrode blocks 3i of the head (T) are in their extreme down position, the internal space 5i of each module (Mi) forms a single elongated cavity 5 for which the section is approximately identical over the entire width of the head.

According to the invention, means are provided on the path of each jet to measure the velocity of this jet.

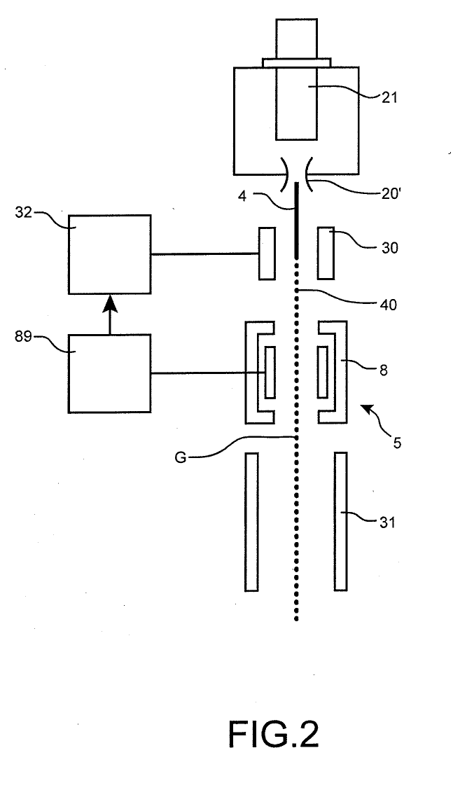

Thus, as shown in FIG. 2, each drop in the jet exits from the orifice 20′ of the corresponding ink ejector 20, and then passes successively between the charge electrodes 30, and through jet velocity measurement means 8 (not shown in FIG. 1B), arranged on the downstream side of the location at which drops are formed and charged. Finally, each drop passes between the deviation electrodes 31. This figure also shows the means 89 that form a circuit that processes signals sampled from the means 8 and outputs a signal representative of the passage of charged drops in front of the detection electrodes. At least the jet velocity is calculated using this signal. Instantaneous values can be filtered and averaged to avoid aberrant values. Furthermore, electrodes 30 are controlled by means 32 for generating a voltage that will charge the drops 40 in the jet 4. According to the invention, a signal from means 89 will enable control over the means 32 for defining the voltage to be applied to the electrodes 30. Therefore, these means 32 themselves are controlled by means 89 for calculating or evaluating the velocity of the jet or drops in the jet, using velocity measurement device 8. The means 32, 89 associated with each print head may form part of the electronic means 17 (FIGS. 1A and 1B).

The velocity measurement means 8 are preferably positioned on the electrode support part 3 (the block of electrodes in FIG. 1B). Thus, access to all electrodes and to the velocity measurement means is possible in the raised position of this part 3 relative to the fixed body 1. Therefore, all these electrodes and means are aligned, and in the low position of part 33, a jet of drops can pass through these different means successively.

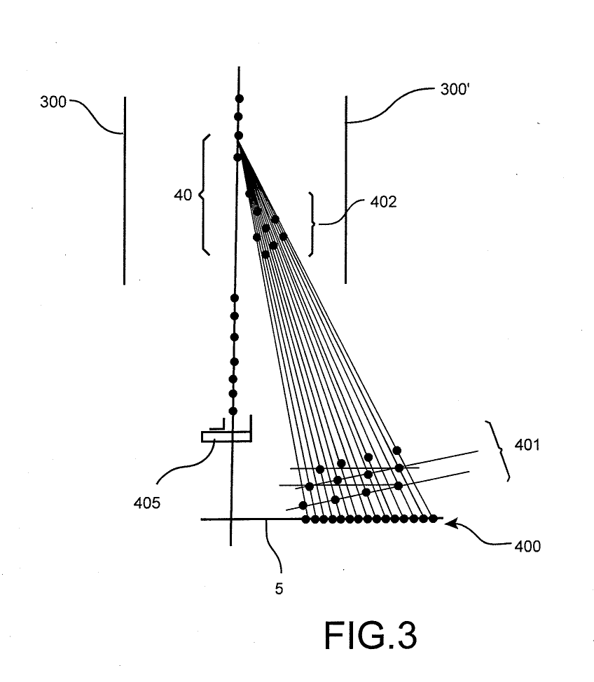

FIG. 3 diagrammatically shows a set of drops 40 projected by a jet between two deflection electrodes 300, 300′ (this figure is not to scale). This figure also shows a frame of drops 400 deposited on the support S to be printed, a burst of drops 401 close to the substrate and a burst of drops 402 at the exit from the electrodes. The reference 405 denotes a drop recovery gutter for undeviated drops.

FIG. 3 shows that the set 40 of drops forms a cluster that forms a very complex set. The drops 40 interact with each other, in various ways. Firstly, there is an aerodynamic type interaction, displacement conditions of a drop depending on the presence of adjacent drops, and on displacement conditions of each of these neighbouring drops. There is also an electrostatic type interaction, because each drop carries a negative electrical charge, which causes the creation of a repulsive force between the different drops in the cluster. Therefore, it can be understood that determining the voltage to be applied to charge the drops depends on very many factors.

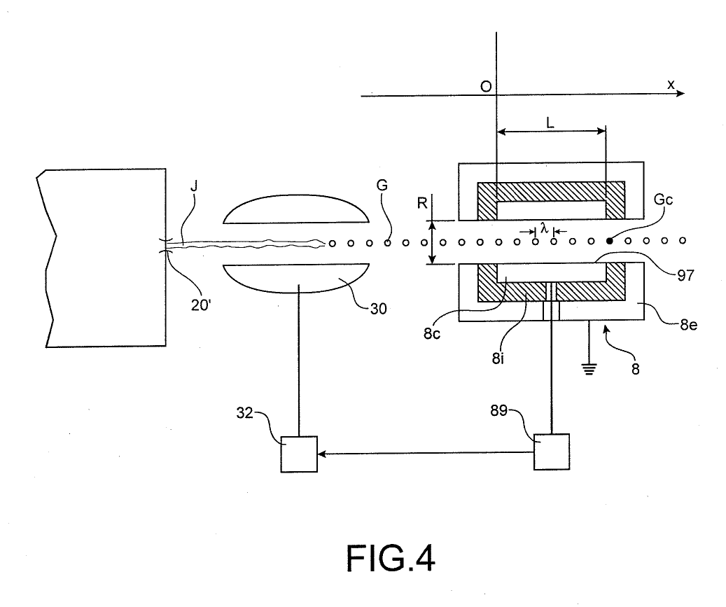

FIG. 4 diagrammatically shows a device 8 for detection of the drop velocity. Such a device is described more precisely in document EP 0 362 101.

As already explained above, the velocity detection electrode is placed immediately on the downstream side of the location at which the drops are formed and charged. FIG. 4 illustrates the passage of a single charged drop 40 with charge Qg, shown in black and located close to the active conducting element 8c of the detector 8. The detector is electrically connected to the electrical velocity detection circuit 89. The velocity detection electrode 8 comprises a central conducting element 8c, preferably protected from the influence of external electrical charges (present in particular on the charge electrode 30) due to an insulation thickness 8i and an external conducting element 8e called the guard electrode, electrically connected to the ground. In one preferred embodiment, the detector 8 has a plane symmetry and the drops 40 move along the axis of a slit made on the axis of symmetry of the detector. However, any other configuration of the detector symmetric about to the axis of the path of the drops will be suitable. The drops 40 move at an approximately uniform translation velocity V in the detector, and are oriented along the detector axis.

As described in detail in the above-mentioned document, the proximity of a charged drop 40 in detector 8 leads to the appearance of electrical charges with the opposite sign on the surface of the detector, due to electrostatic influence. If the influence of the insulator 8i is neglected, this charge quantity may be represented in the form of a linear charge density σ(x).

Document EP 362 101 also describes the creation of a device 89 to exploit signals sampled in detector 8. Such a device can detect a current that circulates between the guard electrode 8e and the ground.

In general, the measurement precision can be increased not only by using a single jet velocity measurement, but also by using a set of successive measurements of the velocity of this jet, for which the average is then determined. In both cases, the expression <<jet velocity>> is used in this document. The device described above can be used to make such a measurement and then to calculate the averages.

According to the invention, the inventors have determined that it is possible to use a modification to voltage conditions applied to jet drop charge electrodes, to modify the velocity of this jet and in particular the velocity as measured as described above. In other words, a variation of a jet velocity can be compensated by a variation of the voltage applied to the charge electrodes, and therefore a variation of the charge applied to each drop in a set of drops in a jet.

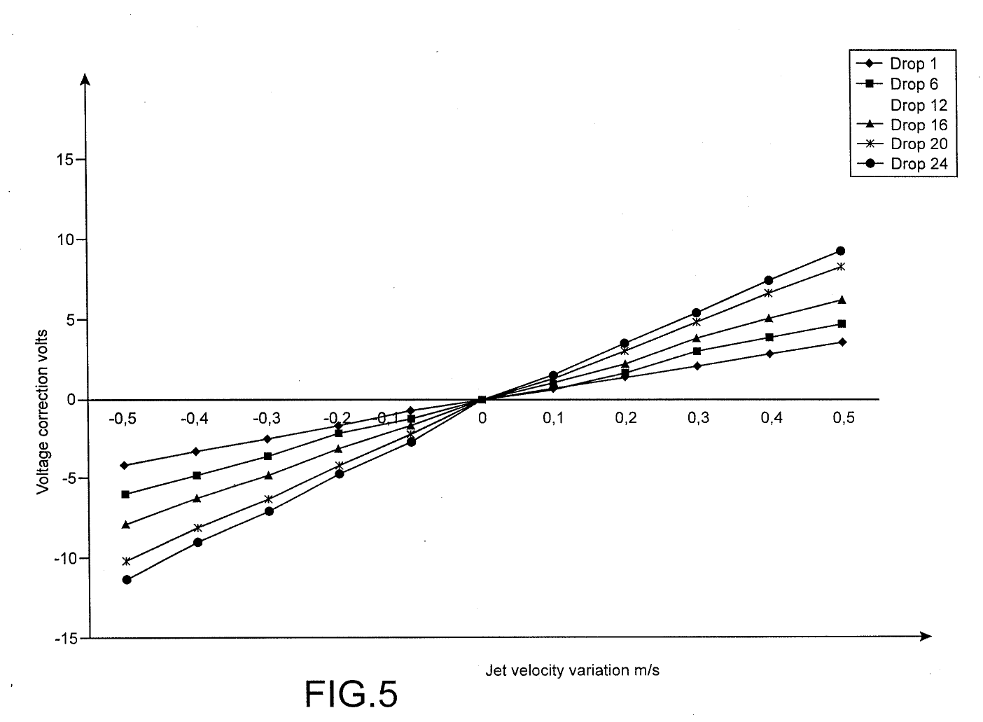

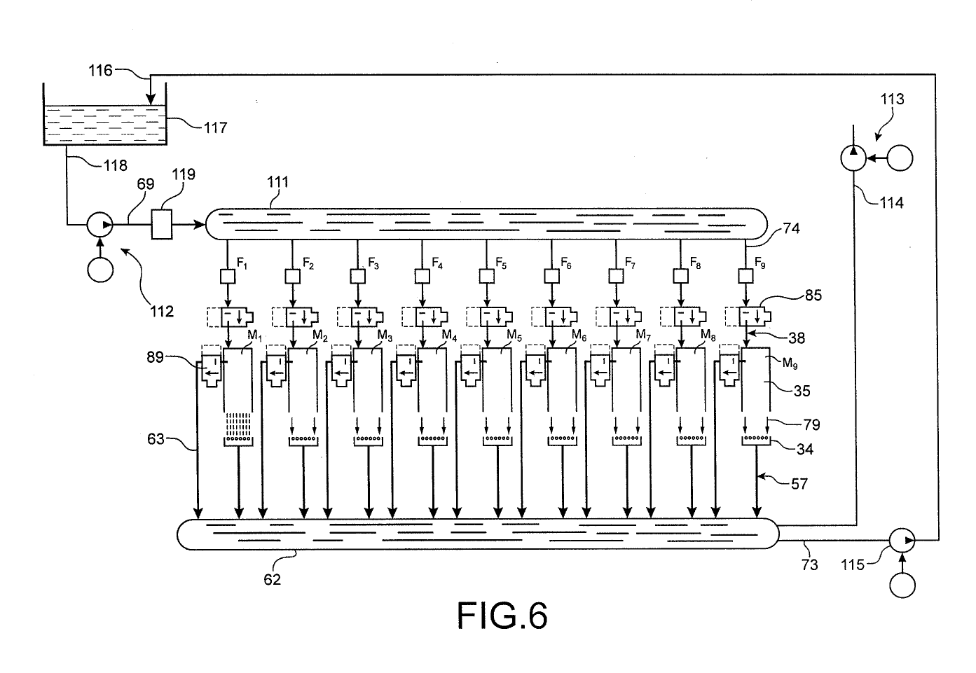

FIG. 5 shows a real example of voltage correction profiles to be applied to charge electrodes 30 as a function of the variation of the velocity observed using means 8. In this figure, it can be seen that various profiles are identified which correspond to drops 1, 6, 12, 16, 20 and 24 respectively in a jet. For each, this is the charge voltage correction profile as a function of the number of the drop in the jet. Thus, in a single jet, the correction to the voltage applied for drop 1 is different from the correction to the voltage applied for drop 6, . . . . This is due to the fact that as explained above, the environment of each drop is different from the environment of other drops, due to the variety of aerodynamic and electrostatic interactions. Note here that the objective is mainly to correct the effects related to a common cause such as dirt accumulation in a filter, and this is why the variation of the jet velocity at the module is measured, but the appropriate correction is then applied to each of the drops in a plurality of drops as a function of its environment.

A measurement of a jet velocity may be disturbed or inaccurate, since the measured velocity does not represent the real velocity of the jet. For example, in some cases, the measurement device associated with a jet may itself be dirty. Thus, as shown in FIG. 4, it is possible that an ink deposit 97 on one of the electrodes of the velocity measurement device affects the measurement made using this device, for all drops in the same jet.

This is why the invention includes a check procedure, for example implemented by means 17 or by the computer of the print card that controls the jets, for example the eight jets in a module, in order to identify measurements that can be qualified as being disturbed or inaccurate, and measurements that can be considered as valid or not disturbed and correct.

This control procedure uses the reference velocity of each jet in a group or a given module. Remember that this reference velocity is a characteristic element of a module in good operating condition. The system may record this velocity, for example under control of the operator when he validates adjustments made to the jets during jet connection operations.

The velocity of each jet in a group of jets or a module is measured for this purpose. As mentioned above, the average velocity of a set of velocity measurements can be calculated, each of these measurements corresponding to the same jet in a print module. In both cases, the expression <<jet velocity>> is used.

The average of the velocities in the different jets in the module can then be calculated.

We can then calculate:
a first difference between this average velocity and the average reference velocity of each jet in said set of jets;
then a second difference between the instantaneous velocity and the reference velocity of each jet in said group of jets;
then a third difference between the first difference and the second difference;

If the third difference remains below a given value (determined by an operator or programmable), then the jet measurement is considered to be valid.

According to one variant, it is possible to:
determine an average velocity of all jets in a group of jets or a module;
calculate the difference between this average velocity and the average of the reference velocities of jets in the group or the module considered (this difference is related to phenomena that are to be compensated, such as clogging of module filters);
correct the measured velocity by this difference.

This corrected velocity is then compared with the jet reference velocity.

When the difference between the corrected velocity and the reference velocity is greater than a predetermined or programmable value, the measurement is declared to be incorrect.

As we will see below, jet velocity measurements can be validated in some velocity correction methods. Furthermore in some cases, if the number of jets in a module for which the measurement is valid and greater than a predetermined number, it can be deduced that a compensation can be applied.

There are several compensation methods, and they have already been presented above.

The first method consists of making an individual correction to each jet. This correction is equal to the difference between the measured jet velocity and the reference velocity of this jet. This mode cannot detect jets for which measurements are bad.

In the second method, the difference in the averages of the reference velocities and the averages of measured velocities validated in each jet of a single module is used. The correction of the charge aims at obtaining a correction to the velocity of each jet, equal to the difference between the average velocity of all jets in the group of jets, and the average of the reference velocities of jets in this group (correction said to be <<average>>). One condition prior to application of this correction is that the number of jets in the module for which a measurement is valid (in the sense already described above) is greater than a predetermined number.

In the third method, the difference between the nominal velocity and measured velocity is used for each jet for which the measurement is valid. The difference between the averages (<<average>> correction explained above) is applied to jets for which the measurement is not valid as in the second method described above.

For the second and third methods, after a measurement validation step, the averages of measured velocities and reference velocities can also be recalculated for valid jets, excluding measurements of jets that are identified as being invalid.

For example, consider a set of eight jets for which the nominal velocities (for example obtained by measurement at time t₀) are given by line 2 in table I below.

Firstly, a procedure is implemented to validate measurements made on the jets.

Lines 3 and 4 indicate the reference velocity and the measured (or instantaneous) velocity respectively, for each jet. The last column contains the average value of each line. During printing (at time t₁), it is found that jets 1 to 8 have measured velocities corresponding to an average velocity of 18.268 m/s instead of an average reference velocity of 18.512 m/s.

For each jet:
the value in line 5 indicates the difference between the reference velocity and the measured velocity; the last column contains the difference between the average reference velocity and the measured average velocity which in this case is equal to 0.243 m/s. In this example, it should be noted that all jets in the module have a lower velocity than the average reference velocity;
line 7 gives the absolute value of the difference between the reference velocity and the measured velocity (difference in line 5) and the difference between the averages (equal to the value given in the last column in line 5);
the value in line 8 indicates whether or not the value in line 7 is less than a threshold or a tolerated difference value (in this case 0.05); if it is the value 1 is assigned to the jet, and if it is not the value 0 is assigned to the jet. In the case illustrated here, the value is correct for 5 jets, but the table shows that jets 1, 4, 5 do not have a correct behaviour or a correct measurement. Therefore they will not be used in the remainder of the calculations.

TABLE 1

| 1 | | Jets | | | | | | | | |
|---|---|---|---|---|---|---|---|---|---|---|
| 2 | | 1 | 2 | 3 | 4 | 5 | 6 | 7 | 8 | Average |
| 3 | Reference velocity | 18.68 | 18.7 | 18.42 | 18.5 | 18.36 | 18.53 | 18.47 | 18.44 | 18.5125 |
| 4 | Measured velocity | 18.33 | 18.45 | 18.17 | 18.32 | 18.17 | 18.31 | 18.2 | 18.2 | 18.26875 |
| 5 | Difference | 0.35 | 0.25 | 0.25 | 0.18 | 0.19 | 0.22 | 0.27 | 0.24 | 0.24375 |
| | between ref and | | | | | | | | | |
| | measurement | | | | | | | | | |
| 6 | | | | | | | | | | |
| 7 | ABS (jet | 0.10625 | 0.00625 | 0.00625 | 0.06375 | 0.05375 | 0.02375 | 0.02625 | 0.00375 | 0 |
| | difference- | | | | | | | | | |
| | average | | | | | | | | | |
| | difference) | | | | | | | | | |
| 8 | Jets valid if ABS | 0 | 1 | 1 | 0 | 0 | 1 | 1 | 1 | 5 |
| | (Jet difference- | | | | | | | | | |
| | average | | | | | | | | | |
| | difference) < | | | | | | | | | |
| | tolerated | | | | | | | | | |
| | difference | | | | | | | | | |

It is then possible to use one of the correction procedures already described above, in the event the example of the third compensation method described above is used. Table 2 shows the correction calculation mechanism.

TABLE 2

| | Jets | | | | | | | | |
|---|---|---|---|---|---|---|---|---|---|
| | 1 | 2 | 3 | 4 | 5 | 6 | 7 | 8 | Average |
| Valid Vref | 0 | 18.7 | 18.42 | 0 | 0 | 18.53 | 18.47 | 18.44 | 18.512 |
| Valid | 0 | 18.45 | 18.17 | 0 | 0 | 18.31 | 18.2 | 18.2 | 18.266 |
| measurements | | | | | | | | | |
| Difference | | | | | | | | | 0.246 |
| Applied | 0.246 | 0.25 | 0.25 | 0.246 | 0.246 | 0.22 | 0.27 | 0.24 | 0.246 |
| correction | | | | | | | | | |

Averages of the measured jet velocities and reference velocities are recalculated, considering only the jets for which measurement was already validated. The difference between the two averages is calculated (0.246 m/s in this case).

The last line in the table shows the correction applied according to the third method already described above. In the case of a correction according to the second method already described above, the correction of 0.246 m/s will be applied to all jets.

Each jet in the print device is equipped with a set of electrodes and means for measuring the velocity of ink drops as described above. Therefore the velocity of all jets is controlled in the same way. As explained above, if the velocity of one of the jets drifts significantly, a correction can be made that will take account of the velocities of jets belonging to the same module.

The invention can also be applied to a wide format print head moved over a support either perpendicular to the direction of the strip or parallel to it.

The invention can also be applied to so-called scanning heads.

1. A process for compensating for effects related to variations in the velocities of electrically charged ink drops in a jet output from a print head of a printer, the drops being electrically charged by charge electrodes, comprising:
measuring the velocity of a jet on the downstream side of the charge electrodes, and calculating a variation in the jet velocity,
determining whether or not the measured velocity of each jet in a group of jets can be considered as being valid,
for each drop, determining a voltage correction value to be applied to the drop charge electrodes, as a function of the measured velocity variation.

2. The process according to claim 1, the drop trajectories being modifiable by deviation electrodes.

3. The Process according to claim 1, further comprising applying a charge correction to drops in a jet in a variable manner as a function of the position of each drop in the jet.

4. The process according to claim 1, wherein determining whether or not the measured velocity of each jet in a group of jets can be considered as being valid comprises:
calculating a first difference between the measured average velocity and the reference average velocity of each jet in the group of jets;
calculating a second difference between the instantaneous velocity and the reference velocity of each jet in the group of jets;
calculating a third difference between the first difference and the second difference.

5. A process according to claim 1, in which a voltage correction is made and applied to the drop charge electrodes, so as to obtain:
a) a correction to the velocity of each jet individually, equal to the difference between the measured velocity of the jet and a corresponding reference velocity;
b) or a correction to the velocity of each jet in a group of jets, equal to the difference between the average velocity of all jets in the group of jets, and the average of corresponding reference velocities of this group, if the number of jets in the group with a valid measurement is greater than a predetermined number;
c) or a correction to the velocity of each jet in a group of jets:
equal to the difference between the average velocity of all jets in the group of jets, and the average of the corresponding reference velocities of the jets in this group if the jet has an invalid velocity measurement;
equal to the difference between the measured velocity of the jet and the corresponding reference velocity, if the jet has a valid velocity measurement.

6. A process according to claim 5, in which the average velocity of all jets in the group of jets for which the measurement is valid, and the average of the corresponding reference velocities of jets for which the measurement is valid are recalculated, to apply corrections b) or c).

7. A print head for an ink jet print device, comprising:
ink ejection means for producing a jet of ink drops,
charge electrodes, configured to electrically charge the drops in a jet produced by the ink ejection means,
means for measuring the velocity of each drop, on the downstream side of the electrodes to electrically charge the drops, and to calculate a variation of this measured velocity,
means for determining whether or not the velocity measurement of each jet in a group of jets can be considered as being valid,
means of for determining a voltage correction value to be applied to the drop charge electrodes, as a function of the variation of this measured velocity,
deviation electrodes to modify the drop trajectories.

8. The print head according to claim 7, wherein the means for determining a voltage correction value to be applied to the charge electrodes being used to determine a variable correction as a function of the position of the drops in a jet.

9. The print head according to claim 7, wherein the means for determining whether or not the measured velocity of each jet in a group of jets can be considered as being valid comprise means for:
calculating a first difference between the measured average velocity and the reference average velocity of a set of jets in the group of jets;
calculating a second difference between the instantaneous velocity and the reference velocity of each jet in the group of jets;
calculating a third difference between the first difference and the second difference,
calculating whether or not the measurement is valid, depending on the value of the third difference.

10. A print head according to claim 7, in which the means for determining a voltage correction value to be applied to the drop charge electrodes for each drop can be used to determine a voltage correction in order to obtain:
a correction to the velocity of each jet individually, equal to the difference between the measured velocity of the jet and its corresponding reference velocity;
or a correction to the velocity of each jet in a group of jets, equal to the difference between the average velocity of all jets in the group of jets and the average of the corresponding reference velocities of the jets in this group, if the number of jets in the group with a valid measurement is greater than a predetermined number;
or a correction to the velocity of each jet in a group of jets:
equal to the difference between the average velocity of all jets in the group of jets, and the average of the corresponding reference velocities of the jets in this group, if the jet has an invalid velocity measurement;
equal to the difference between the measured velocity of the jet and its corresponding reference velocity, if the jet has a valid velocity measurement.

11. A print head according to claim 7, comprising a support block to hold the charge electrodes in place, means of measuring the velocity of each drop and the deviation electrodes.

12. A print head according to claim 11, comprising a fixed body fixed relative to a support beam, wherein the fixed body comprises the means for producing a jet of ink drops, and wherein the support block is fixed on a fixed part, but is free to move relative to it.

13. A print head according to claim 12, the electrode support block pivoting about a rotation axis defined in the fixed body, the charge electrodes, the means for measuring the velocity of each drop, and the deviation electrodes being aligned on the trajectory of the drops in a jet, in a lowered position of the block relative to the fixed body.

14. A print head according to claim 13, wherein the block of electrodes pivots between its operating position and an extreme raised position to allow maintenance of the ink ejection means, means for measuring the velocity of each drop and/or the block of electrodes.

15. A print head according to claim 7, wherein the fixed body and the electrodes block define an output orifice when the block is in the lowered position relative to a fixed part, at least part of the ejected ink passing through the orifice to print on a moving support.

16. A print head according to claim 15, the electrodes block being in the form of a shoe in its lower part, the shoe being separated from the body by a width defining the output orifice, a volume delimited by the body and the block in the operating position defining a cavity opening onto the output orifice.

17. A print head according to enema claim 7, in which the ink ejection means are adapted to eject ink in the form of continuous jets, or to eject one or several drops on request.

18. A wide print device according to claim 7, comprising a plurality of modules side by side along the same transverse axis.
